(19) United States
(12) Patent Application Publication
(10) Pub. No.: US 2013/0275455 A1
(43) Pub. Date: Oct. 17, 2013

(54) ASSOCIATING USERS VIA A SEARCH

(71) Applicant: Debajyoti Dutta, Bangalore (IN)

(72) Inventor: Debajyoti Dutta, Bangalore (IN)

(73) Assignee: YAHOO! Inc., Sunnyvale, CA (US)

(21) Appl. No.: 13/445,817

(22) Filed: Apr. 12, 2012

(51) Int. Cl. G06F 17/30

(52) U.S. Cl. 707/769; 707/E17.014

(57) ABSTRACT

Example methods, apparatuses, or articles of manufacture are disclosed that may be implemented, in whole or in part, using one or more computing devices to facilitate or otherwise support one or more processes or operations for associating users via a search.

### BACKGROUND

1. Field

The present disclosure relates generally to search engine content management systems and, more particularly, to associating users via a search for use in or with search engine content management systems.

2. Information

The Internet is widespread. The World Wide Web or simply the Web, provided by the Internet, is growing rapidly, at least in part, from the large amount of content being added seemingly on a daily basis. A wide variety of content, such as one or more electronic documents, for example, is continually being identified, located, retrieved, accumulated, stored, or communicated. Effectively or efficiently identifying or locating content on the Web may facilitate or support information-seeking behavior of users, for example, and may lead to an increased usability of a search engine. In addition to retrieving content, search engines may, for example, employ one or more functions or processes to rank content, such as retrieved documents using one or more ranking measures.

In addition, social communication arrangements supported by the Internet, such as, for example, on-line social networks, web-based virtual communities, or the like continue to evolve. For example, on-line social content, such as personal blogs, news feeds, user portals, status updates, or the like is generated by an ever-increasing number of members across one or more social networks and, at times, openly published on the Web. Social networking is gradually becoming more widespread due to, for example, its convenience, immediacy, portability, appeal, interactive nature, etc., thus, increasing a utility of content associated with a social networking community.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating certain features of an implementation of an example computing environment.

FIG. 2 is a schematic diagram of an implementation of an example social structure.

FIGS. 3A and 3B are example representations of screenshot views of a display associated with a client device according to an implementation.

FIG. 4 is a flow diagram illustrating an implementation of a process for associating users via a search.

FIG. 5 is a schematic diagram illustrating an implementation of a computing environment associated with one or more special purpose computing apparatuses.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be used, in whole or in part, to facilitate or support one or more processes or operations for associating users via a search. In some instances, a search may comprise, for example, an on-line search that may be performed in connection with a search engine. As used herein, “on-line” may refer to a type of a communication that may be implemented via one or more communications networks, such as, for example, the Internet, an intranet, a communication device network, or the like. Communications networks may comprise, for example, a wireless network, wired network, or any combination thereof. A search engine may typically comprise a content retrieval computing platform that may, for example, help a user to locate or retrieve on-line content, such as one or more web documents of a particular interest. As used herein, the terms “web document” or “electronic document” may be used interchangeably and may refer to one or more digital signals, such as communicated or stored signals, for example, representing any content including a source code, text, image, audio, video file, or the like. Web documents may, for example, be processed by a special purpose computing platform and may be played or displayed to or by a user, member, or client. The terms like “user,” “social user,” “participant,” “member,” or “client” may be used interchangeably herein. At times, web documents may include one or more embedded references or hyperlinks to images, audio or video files, or other web documents. For example, one common type of reference may comprise a Uniform Resource Locator (URL). As a way of illustration, web documents may include a web page, an electronic user profile, a news feed, a rating or review post, a status update, a portal, a blog, an e-mail, a text message, a link, an Extensible Markup Language (XML) document, a media file, a web page pointed or referred to by a URL, just to name a few examples.

A search engine may further arrange or present retrieved content, such as, for example, one or more web documents relevant to a search query in a variety of formats. For example, a search engine may arrange web documents in an ascending or descending order of keyword relevance in a listing of returned search results, just to illustrate one possible implementation. Relevance of a web document to a search query may, for example, be determined based, at least in part, on an analysis of keywords, tags, URLs, or the like within the document using one or more appropriate techniques. As used herein, “keyword” may refer to one or more words used in a title or a phrase within a web document that may designate or otherwise suggest content of the web document. In some instances, a search engine may, for example, present retrieved content in a listing of returned search results in the form of one or more links to relevant web pages. Of course, these are merely details relating to search engines and claimed subject matter is not so limited.

As alluded to previously, the difficulty of locating or retrieving content of interest may typically increase as the amount of available content increases. For example, as more content of potential interest becomes available, content of particular interest may be more difficult to locate. In addition, it may be useful to associate content of interest with one or more social connections, such as users with some level of mutual social relationship. Consider, for example, a scenario in which a user may wish to apply to a particular school, have specific questions, or otherwise would like to obtain additional information not listed on the school's web site, such as, for example, professors' helpfulness, clarity of presentations, teaching styles, classroom environment, grading policies, or the like. One possible approach may include, for example, searching for or “virtually” navigating to one or more social networking web sites in trying to locate potential or useful social connections within a school-related community. As will be seen, social connections may comprise, for example, one or more social friends, acquaintances, followers, members, subscribers, or the like with some level of mutual social relationship. Another approach may comprise, for example, posting specific questions in question-answering web sites or forums, if available, and wait for someone to reply, if at all. Yet another possible approach may comprise, for example, performing a question-related on-line search via a typical search engine, which may or may not produce desirable results.

A similar scenario may apply to a user researching a particular company or organization, such as for an upcoming job interview, for example, who may wish to locate social friends associated with that organization that might be able to answer specific questions, provide advice, or, perhaps, give a recommendation. Likewise, here, a user may resort to searching for an organization of interest, such as via a search engine, for example, and following a number of links in a listing or returned search results in trying to locate potential or useful social connections, find answers, or the like, which at times may be time-consuming. Accordingly, it may be desirable to develop one or more methods, systems, or apparatuses that may associate content of interest with certain users, such as users having some level of social relationship, for example, in a more effective of efficient manner, such as via a search. This may, for example, make search results more social, enhance user searching experience, lead to an increased usability of a search engine, or the like.

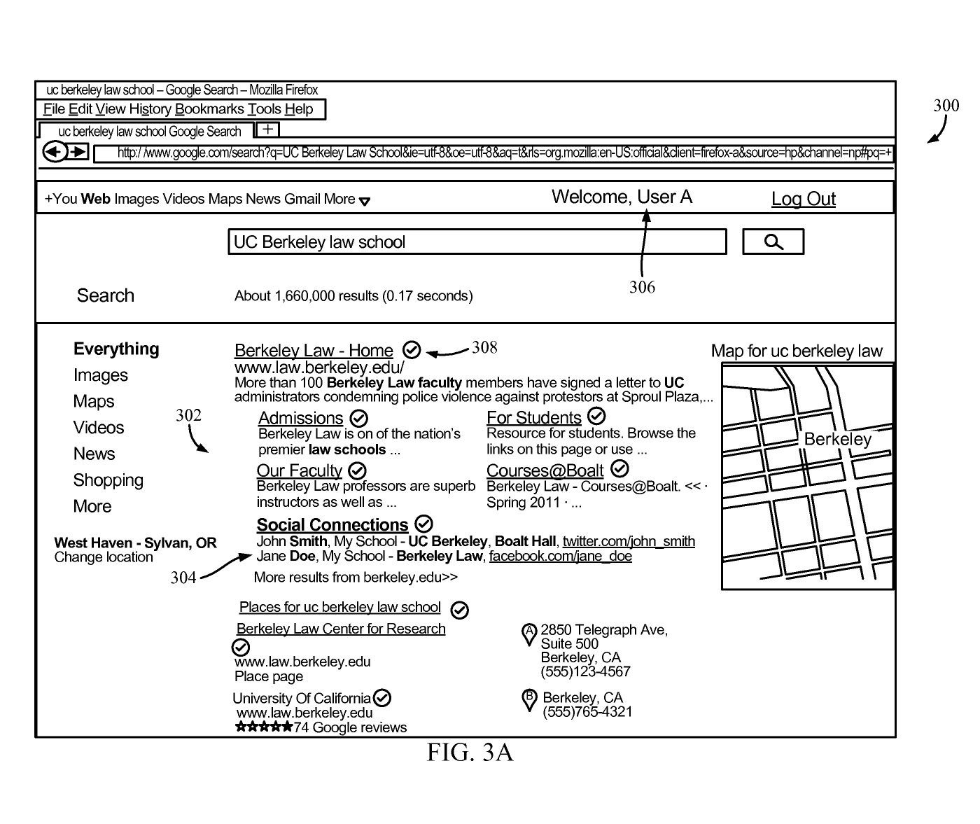

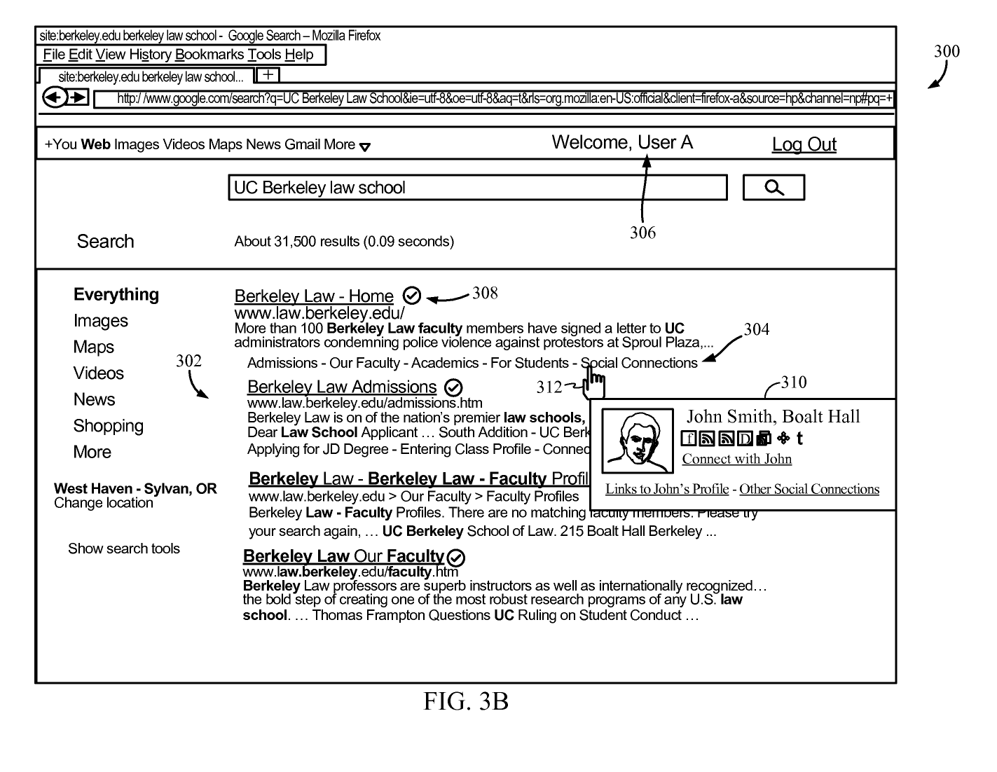

For example, in an implementation, instead of or in addition to returning links to relevant web pages (e.g., organizations, universities, locations, etc.), a search engine may return names or suitable contact information for one or more social users associated with these web pages. More specifically, a search engine may, for example, identify one or more users socially associated with a particular school, organization, physical location, company, or the like and may display these users in some manner in a listing of returned search results. At times, users may, for example, socially associate themselves with a particular school, organization, company, etc. in electronic profiles on one or more social networking services or platforms, such as Facebook®, MySpace®, LinkedIn®, Twitter®, Jaiku®, or the like accessible by a search engine. For example, as described below, a listing of returned search results may display a number of links to relevant web pages (e.g., organizations, universities, locations, etc.) with identities of one or more associated users listed below these links, though claimed subject matter is not so limited. In some instances, user identities, such as names of associated users, if applicable, may, for example, appear in a hover box while an on-screen cursor is moved or placed over a link of interest (e.g., a mouse-over, tooltip, etc.), just to illustrate a possible implementation. Optionally or alternatively, identities of one or more associated users may be listed under a suitable header, such as “Social Connections,” for example, next to an applicable link in a listing of returned search results. Again, claimed subject matter is not so limited, of course. Particular examples of social connections associated with web documents of interest, such as in a listing of returned search results, for example, will be described in greater detail below with reference to FIGS. 3A and 3B.

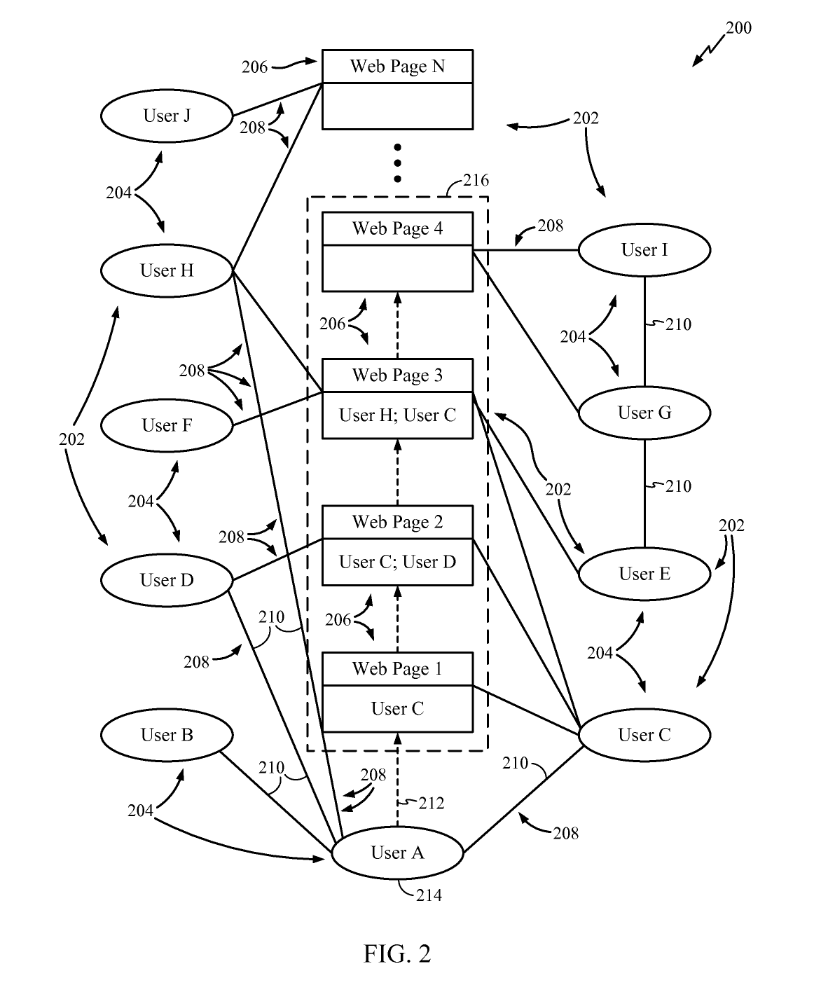

In some implementations, a search engine may comprise a suitable application or process, such as a web indexer or crawler, for example, that may browse or “crawl” the Web in a relatively methodical manner so as to identify or locate one or more web documents of interest. Based, at least in part, on a “crawl,” a search engine may index Web addresses or URLs, for example, associated with located web documents in a suitable repository of indexed documents via appropriate classification methodology. In some instances, such as while building a suitable index, for example, a search engine may generate a suitable social structure, such as a social graph or sociogram-type structure. It should be appreciated that in certain implementations a social graph or sociogram-type structure may be generated independently of indexing or crawling. As will be seen, in some instances, a social graph or sociogram-type structure may comprise, for example, one or more web documents and one or more social users associated with these documents, such as via one or more social ties or links, though claimed subject matter is not so limited. A particular example of a social graph or sociogram-type structure will be described in greater detail below with reference to FIG. 2. A social graph or sociogram-type structure may be updated in a suitable manner, such as on an hourly or daily basis, for example, which may or may not correspond to updating a search index, such as via a crawl.

According to at least one implementation, a search engine may, for example, identify one or more users associated with one or more web documents by accessing electronic profiles of these users on one or more social networking services or platforms, as previously mentioned. In some instances, users may list or advertise an association by tagging or otherwise providing a link to a particular web page, such as, for example, a user's school, employer, company, organization, or the like. To illustrate, a user may tag or list “My Company” as “www.yahoo.com” in a user-related profile on a particular social networking web site, for example, while another user may tag or list “www.yahoo.com” as “My Employer” in some virtual forum. In some instances, such as while building a social index, for example, a search engine may access profiles of these users and may generate a suitable social graph or sociogram-type structure linking these users with a tagged or listed web page, such as “www.yahoo.com.” As such, in some instances, a social graph or sociogram-type structure may comprise, for example, an electronic representation of a network of associated persons comprising one or more web pages and social users linked to respective web pages, as will be seen. In this context, persons may comprise, for example, one or more users, entities, individuals, or any combination thereof. Of course, this is merely an example of a social graph or sociogram-type structure that may be employed, at least in part, and claimed subject matter is not so limited.

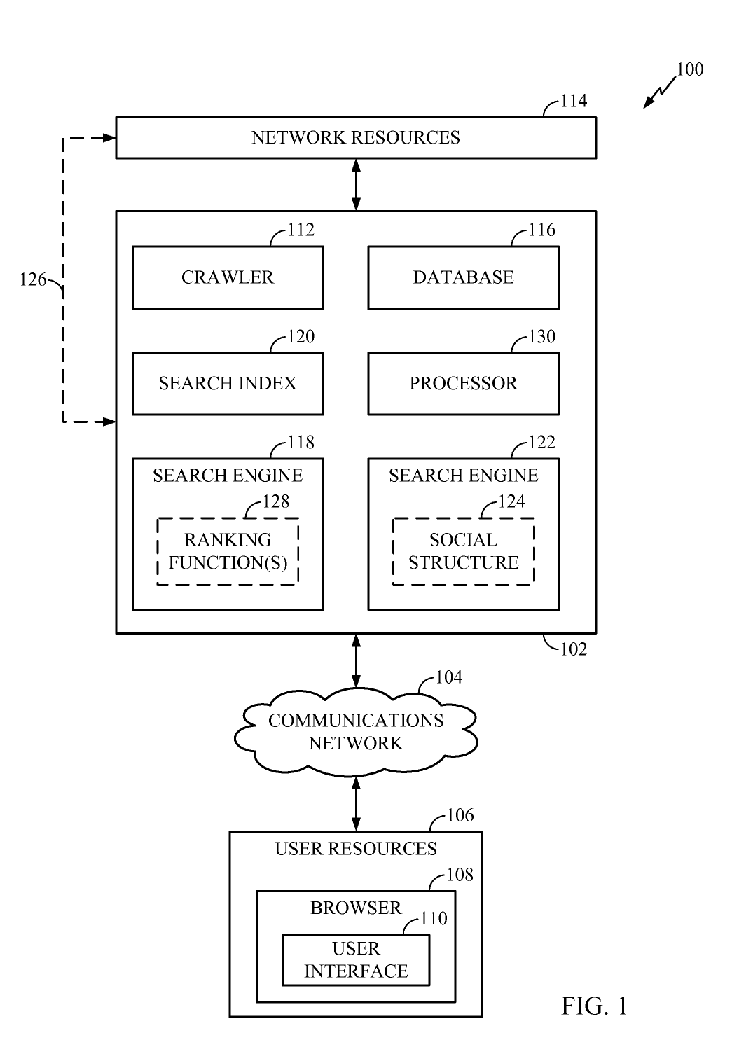

With this in mind, attention is now drawn to FIG. 1, which is a schematic diagram illustrating certain features of an implementation of an example computing environment 100 capable of facilitating or supporting, in whole or in part, one or more processes or operations for associating users via a search. Computing environment 100 may be operatively enabled using one or more special purpose computing apparatuses, communication devices, storage devices, computer-readable media, applications or instructions, various electrical or electronic circuitry, components, etc., as described herein with reference to example implementations.

As illustrated, computing environment 100 may include one or more special purpose computing platforms, such as, for example, a Content Integration System (CIS) 102 that may be operatively coupled to a communications network 104 that a user may employ in order to communicate with CIS 102 by utilizing resources 106. CIS 102 may be implemented in connection with one or more public networks (e.g., the Internet, etc.), private networks (e.g., intranets, etc.), public or private search engines, Real Simple Syndication (RSS) or Atom Syndication (Atom)-based applications, etc., just to name a few examples.

Resources 106 may comprise, for example, one or more special purpose computing client devices, such as a desktop computer, laptop computer, cellular telephone, smart telephone, personal digital assistant, or the like capable of communicating with or otherwise having access to the Internet via a wired or wireless communications network. Resources 106 may include a browser 108 and a user interface 110, such as a graphical user interface (GUI), for example, that may initiate transmission of one or more electrical digital signals representing a search query. User interface 110 may interoperate with any suitable input device (e.g., keyboard, mouse, touch screen, digitizing stylus, etc.) or output device (e.g., display, speakers, etc.) for interaction with resources 106. Even though a certain number of resources 106 are illustrated, it should be appreciated that any number of resources may be operatively coupled to CIS 102, such as via communications network 104, for example.

As previously mentioned, in one implementation, CIS 102 may employ a crawler 112 to access network resources 114 that may include, for example, any type of content, such as in the form of stored binary digital signals (e.g., web documents, search query logs, audio, video, image, or text files, etc.). Crawler 112 may store all or part of a located web document (e.g., a URL, link, etc.) in a database 116, for example. CIS 102 may further include a search engine 118 supported by a suitable index, such as, for example, search index 120, a social index 122, etc., and operatively enabled to search for content obtained via network resources 114. Search engine 118 may communicate with user interface 110 and may retrieve for display via resources 106 a listing of suitable search results associating social users by accessing, for example, search index 120 and social index 122 in response to a search query, though claimed subject matter is not so limited.

Network resources 114 may include any type of content, such as represented by stored digital signals, for example, accessible over the Internet, one or more intranets, or the like. For example, network resources 114 may comprise publically accessible content, such as one or more user profiles, associations (e.g., links, etc.), contacts, etc. on a public social network or private content, such as, for example, user profiles, associations, contacts, etc. on a private social network, or any combination thereof. As used herein, “public social network” may refer to a social network in which content (e.g., profiles, status updates, posts, messages, etc.) may be visible to or shared among members of the network or may otherwise be publicly accessible. A “private social network” may, for example, refer to a social network in which content may be visible to or shared among certain members of the network (e.g., close friends, family, etc.) or as permitted by members or social networking platform or service.

Although not shown, content associated with social index 122 may be maintained (e.g., generated, updated, obtained, etc.) by any suitable content extraction engine using one or more appropriate techniques, such as during indexing, caching, crawling, etc. For example, in some instances, social index 122 may be maintained, at least in part, via crawler 112, though claimed subject matter is not so limited. At times, social index 122 may be maintained separately from search index 120, such as on an hourly, daily, etc. basis, for example, using appropriate techniques. Social index 122 may be accessible by search engine 118 and may comprise, for example, social content with respect to one or more members of one or more social networks. In some instances, social content may include, for example, one or more user IDs, user names, user associations, such as tagged web pages (e.g., my school, my company, etc.), URLs to web pages, or the like. Social content may, for example, be used, at least in part, to generate a suitable social structure, indicated generally at 124, such as a social graph or sociogram-type structure, for example. As was indicated, in some instances, a social graph or sociogram-type structure may comprise, for example, an electronic representation of a network of associated persons comprising one or more web pages and social users linked to respective web pages. An example of a social graph or sociogram-type structure that may be employed, at least in part, will be described in greater detail with reference to FIG. 2.

At times, it may be advantageous to utilize one or more real-time or near real-time indexing techniques, for example, so as to keep a suitable index (e.g., social index 122, search index 120, etc.) sufficiently updated. In this context, “real time” may refer to an amount of timeliness of content, which may have been delayed by an amount of time attributable to electronic communication as well as other signal processing. For example, CIS 102 may be capable of subscribing to one or more social networking platforms, content-providing services, or the like via a content feed 126. In some instances, content feed 126 may comprise, for example, a live or direct feed, though claimed subject matter is not so limited. To illustrate, CIS 102 may, for example, be capable of receiving streaming or periodic updates via a suitable API (e.g. Facebook®, etc.) with respect to electronic profiles of existing or additional (e.g., new, etc.) network members, just to illustrate one possible implementation. Of course, these are merely examples relating to indexing techniques to which claimed subject matter is not limited. Feed 126 may be optional in certain example implementations.

In some instances, it may be desirable to rank retrieved web documents so as to assist in presenting relevant or useful content in response to a search query. Accordingly, CIS 102 may employ one or more ranking functions, indicated generally at 128, such as to rank search results in a particular order based, at least in part, on a suitable ranking measure. For example, ranking function(s) 128 may order a listing of search results based, at least in part, on keyword relevance, recency, usefulness, popularity, or the like. Of course, details relating to ranking of search results are merely examples, and claimed subject matter is not limited in this regard. As illustrated, CIS 102 may further include a processor 130 that may, for example, be capable of executing computer-readable code or instructions, implement suitable operations or processes, or the like associated with example environment 100.

FIG. 2 is a schematic diagram of an implementation of an example social structure 200 that may be used, at least in part, to facilitate or support one or more operations or techniques for associating users via a search. As was indicated, social structure 200 may comprise, for example, a social graph or sociogram-type structure represented via a network of associated persons including one or more web pages and social users linked to respective web pages. Social structure 200 may, for example, be represented via content that may be stored in a memory of a suitable special purpose computing platform or device as one or more digital signals. As such, it should be understood that a “node” or “link” may refer to a representation of a node or link as digital signals stored in a memory and accessible by a special purpose computing platform (e.g., CIS 102, search engine 118 of FIG. 1, etc.).

By way of example but not limitation, social structure 200 may comprise, for example, a plurality of nodes 202, which may include one or more user-related nodes 204 and one or more web document-related nodes 206. User-related nodes 204 may comprise any suitable user-related content, such as, for example, a user ID, user name, contact details, link to a user profile (e.g., on a social network, etc.), tagged web pages, etc. that may facilitate or support, at least in part, one or more processes or operations for associating users via a search. Likewise, web document-related nodes 206 may comprise any suitable content relating to a web document of interest, such as, for example, a web page associated with one or more users. Web document-related nodes 206 may, for example, comprise one or more links, URLs, etc. pointing to a suitable web page, blog, profile, or the like. It should be appreciated that content associated with nodes 202 may, for example, comprise public content, private content, or any combination thereof, as discussed above.

As illustrated, nodes 202 of social structure 200 may be at least partially interlinked, such as via associational links or ties, for example, referenced generally at 208, representing social relationships of interest. Relationships between nodes 202 may, for example, be based, at least in part, on suitable types of interdependency, such as friendship, kinship, common interests, activities, events, relationships of workplace or educational institution, geographic location, religious beliefs, or the like. For example, in at least one implementation, relationships of interest, such as between user-related nodes 204 and web document-related nodes 206 may comprise social associations of workplace (e.g., my company, etc.), educational institution (e.g., my school, etc.), etc. obtained via profiles on a social network. Claimed subject matter is not so limited, of course. In some instances, user-related nodes 204 may, for example, be at least partially interlinked, such as via links 210. Thus, social structure 200 may associate persons, such as social users represented via nodes 204, for example, with web documents, such as web pages represented via nodes 206 via corresponding links or ties 202.

According to an implementation, in operative use, a user may access a suitable search engine website, such as www.search.yahoo.com, for example, and may submit a search query via an appropriate technique. In some instances, a search query, such as a query 212, for example, may originate from a user-related node, such as a node 214 associated with a user A, though claimed subject matter is not so limited. Based, at least in part, on one or more search terms, a search engine may look up a search index (e.g., search index 120 of FIG. 1, etc.) and may establish a listing of relevant web documents, referenced generally at 216, employing one or more ranking measures (e.g., keyword relevance, etc.), as discussed above. In addition, a search engine may, for example, access a suitable social structure, such as structure 200, for example, and may identify one or more social users associated (e.g., linked, etc.) with relevant web documents. Here, relevant web documents may comprise, for example, a web page 1 associated with a user C, a web page 2 associated with users C and D, a web page 3 associated with users C, E, F, and H, and a web page 4 associated with users G and I. Of course, claimed subject matter is not limited to particular social users or associations shown.

In some instances, a search engine may prompt a user initiating a search query, such as user A, for example, to log in onto a search engine or service provider-related network, such as Yahoo!® network, for example, so as to identify one or more social connections to the user. Since users in a social structure may be at least partially interlinked, such as via links 210, a relative social location or node of a user initiating a search query within the structure may, for example, be known or provided to a search engine upon logging in. As a way of illustration, for this example, social connections to user A via social structure 200 may comprise, for example, social users B, C, D, and H, though claimed subject matter is not so limited. A search engine may return links to one or more relevant web documents, such as web pages 1 through 4, for example, as well as one or more associated users having some level of social relationship with user A. For example, here, identities of users C, D, and H may be returned to user A as social connections via listing 216 rather than users B, G, or I since these users lack associations with relevant web documents or user A, as seen. In some instances, a relevant web document, such as web page 4, for example, may be returned without social connections due, at least in part, to the lack of appropriate associations, unavailability of social content, inaccessibility of a network, or the like. A search engine may return a listing of search results to be displayed in a suitable manner, such as on a client device, as one possible example.

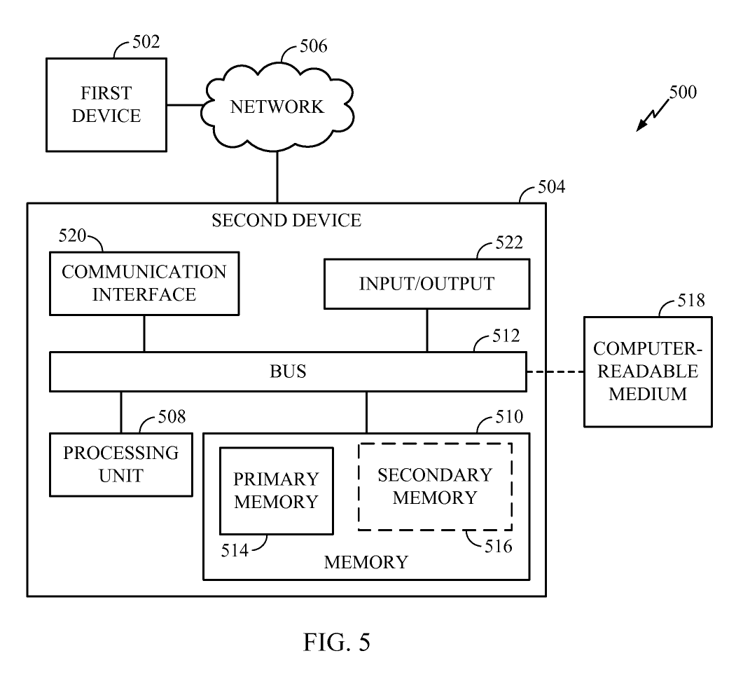

FIGS. 3A and 3B are example representations of screenshot views of a display 300 illustrating a listing of returned search results 302 according to an implementation. As was indicated, listing 302 may associate one or more web documents with one or more users having a social connection to a user initiating a search query, such as user A of FIG. 2, for example. Display 300 or an associated GUI may be operated or otherwise supported by a suitable client device that may communicate with a computing platform (e.g., CIS 102 of FIG. 1, etc.) via an electronic network (e.g., LAN, WAN, the Internet, etc). An example of a client device that may be used herein, at least in part, will be discussed in greater detail below with reference to FIG. 5. To simplify discussion, features or aspects of display 300 shown in FIG. 3A that correspond to like features or aspects illustrated in FIG. 3B may be given corresponding reference numbers, where applicable.

As illustrated in FIG. 3A, listing of returned search results 302 may comprise, for example, a number of links to relevant web pages arranged in a suitable order. As previously mentioned, a user may log in using one or more appropriate techniques, such as with an appropriate user ID (e.g., Yahoo!® ID, etc.) or password, for example, and may view one or more social connections, referenced generally at 304. Listing 302 may be generated, at least in part, via accessing a suitable social structure, such as structure 200 of FIG. 2, for example, in response to a search query (e.g., “UC Berkeley Law School,” etc.). As also illustrated, display 300 may comprise, for example, a suitable log-in indicator 306, realized herein as a personalized greeting (e.g., “Welcome, User A,” etc.), such as to display log-in status regarding a communication connection to a suitable computing platform (e.g., CIS 102 of FIG. 1, etc.).

In at least one implementation, identities of one or more social users may, for example, be displayed below a link to an applicable web page, such as a link 308, under a suitable header, such as “Social Connections,” etc., though claimed subject matter is not so limited. For example, in some instances, identities of one or more social users may be displayed without a heading, immediately next or in any suitable proximity to an applicable link, etc. In other words, any suitable format or arrangement for associating social users may be utilized. As seen in this example, social connections may comprise identities of one or more users, such as, for example, a name of a social user (e.g., John Smith, etc.), tagged association (e.g., My School—UC Berkeley, etc.), link to a user profile (e.g., twitter.com/john_smith, etc.), or the like. Although not shown, in some instances, one or more private social connections, such as connections obtained via accessing a private network, for example, may be displayed and may be labeled accordingly (e.g., “Private Connection,” etc.). A private social connection in a listing of returned search results may, for example, indicate that an associational link between appropriate users has been authorized via one or more appropriate permission or access techniques (e.g., by users, social networking platform, service provider, etc.). Optionally or alternatively, social connections, private or otherwise, may not be labeled.

As seen in FIG. 3B, in some implementations, identities of one or more social users may, for example, appear in a hover box 310 while a pointer 312 is moved or placed over content of interest (e.g., “Social Connections, etc.), such as via a mouse-over or tooltip operation. As used herein, “pointer” may refer to a cursor, arrow, or other suitable icon that may appear on display 300 and may be moved or otherwise controlled with a pointing device to select content, populate fields, input commands, or the like via a GUI of a client device. A pointing device may refer to any device used to control a cursor, arrow, etc. and may include, for example, a mouse, a trackball, a track pad, a keyboard, a stylus, or the like. Hover box 310 may, for example, be rendered via any suitable browser technology and may comprise any suitable content, such as a user's name (e.g., “John Smith,” etc.), link to a user profile or blog, tagged associations, or the like. At times, hover box 310 may, for example, provide a path or “hops” (e.g., “Connect with John,” etc.) to connect with a social user. Of course, these are merely examples of displaying social connections, and claimed subject matter is not limited in scope in these respects.

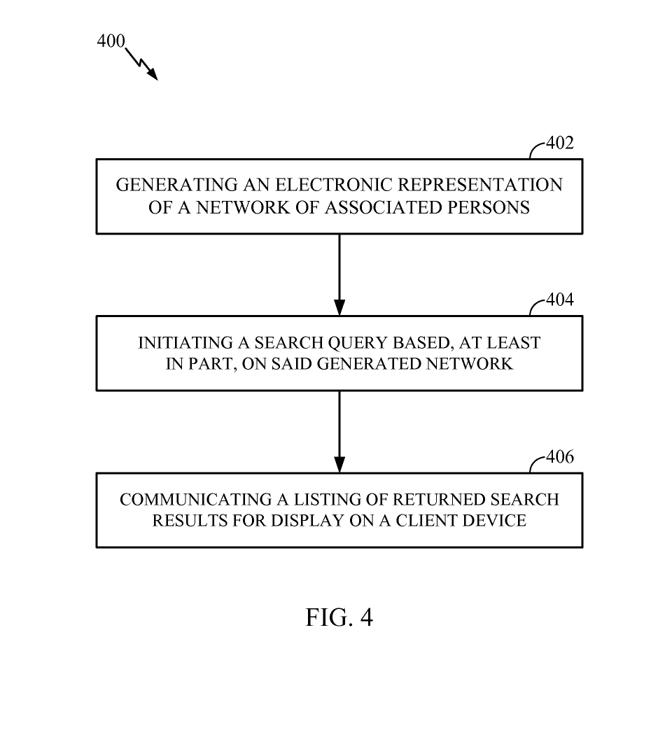

FIG. 4 is a flow diagram illustrating an implementation of an example process 400 that may be performed via one or more special purpose computing devices, in whole or in part, to facilitate or support one or more operations for associating users via a search. It should be noted that content applied or produced, such as, for example, inputs, applications, outputs, operations, results, etc. associated with example process 400 may be represented by one or more digital signals.

Example process 400 may begin, for example, at operation 402, with generating an electronic representation of a network of associated persons. A network of associated persons may, for example, be generated while building a suitable index, such as a search index, a social index, or the like, though claimed subject matter is not so limited. For example, in some instances, a network of associated persons may be generated concurrently with or independently of one or more indexing operations. At times, a network of associated persons may comprise, for example, a social structure, such as a social graph or sociogram-type structure having a plurality of nodes at least partially interlinked via corresponding social ties or links. Nodes may comprise associated persons, such as one or more users, entities, individuals, or any combination thereof, for example, and links may comprise one or more relationships of interest, such as friendship, common interest, relationship of workplace or educational institution, geographic location, or the like. A social structure may be accessible by a search engine, for example.

With regard to operation 404, a search query may be initiated based, at least in part, on a generated network. For example, responsive to a search query, a search engine may look up a suitable index (e.g., a search index, social index, etc.) and may access a generated network of associated persons (e.g., a social structure, etc.). Based, at least in part, on a generated network, a search engine may, for example, identify one or more social users associated with relevant web documents. In some instances, a search engine may prompt a user initiating a search query to log in onto a search engine or service provider-related network, for example.

At operation 406, a listing of returned search results may, for example, be communicated, such as for display on a client device. A listing of search results may, for example, be displayed via a user interface associated with a client device, as one possible example. A listing of returned search results may comprise, for example, a number of web documents arranged in a suitable manner as well as identities of one or more users having associations or social connections with one or more web documents, if applicable. Associating users via a search may, for example, be implemented for use with any suitable search engine or other like content management system responsive to search queries, though claimed subject matter is not so limited.

FIG. 5 is a schematic diagram illustrating an example computing environment 500 that may include one or more devices capable of implementing, in whole or in part, one or more processes or operations for associating users via a search. Computing environment system 500 may include, for example, a first device 502 and a second device 504, which may be operatively coupled together via a network 506. In an embodiment, first device 502 and second device 504 may be representative of any electronic device, appliance, or machine that may have capability to exchange content or like signals over network 506. Network 506 may represent one or more communication links, processes, or resources having capability to support exchange or communication of content or like signals between first device 502 and second device 504. Second device 504 may include at least one processing unit 508 that may be operatively coupled to a memory 510 through a bus 512. Processing unit 508 may represent one or more circuits to perform at least a portion of one or more applicable computing procedures or processes.

Memory 510 may represent any signal storage mechanism or appliance. For example, memory 510 may include a primary memory 514 and a secondary memory 516. Primary memory 514 may include, for example, a random access memory, read only memory, etc. In certain implementations, secondary memory 516 may be operatively receptive of, or otherwise have capability to be coupled to a computer-readable medium 518.

Computer-readable medium 518 may include, for example, any medium that may store or provide access to content or like signals, such as, for example, code or instructions for one or more devices in operating environment 500. It should be understood that a storage medium may typically, although not necessarily, be non-transitory or may comprise a non-transitory device. In this context, a non-transitory storage medium may include, for example, a device that is physical or tangible, meaning that the device has a concrete physical form, although the device may change state. For example, one or more electrical binary digital signals representative of content, in whole or in part, in the form of zeros may change a state to represent content, in whole or in part, as binary digital electrical signals in the form of ones, to illustrate one possible implementation. As such, “non-transitory” may refer, for example, to any medium or device remaining tangible despite this change in state.

Second device 504 may include, for example, a communication adapter or interface 520 that may provide for or otherwise support communicative coupling of second device 504 to a network 506. Second device 504 may include, for example, an input/output device 522. Input/output device 522 may represent one or more devices or features that may be able to accept or otherwise input human or machine instructions, or one or more devices or features that may be able to deliver or otherwise output human or machine instructions.

According to an implementation, one or more portions of an apparatus, such as second device 504, for example, may store one or more binary digital electronic signals representative of content expressed as a particular state of a device such as, for example, second device 504. For example, an electrical binary digital signal representative of content may be “stored” in a portion of memory 510 by affecting or changing a state of particular memory locations, for example, to represent content as binary digital electronic signals in the form of ones or zeros. As such, in a particular implementation of an apparatus, such a change of state of a portion of a memory within a device, such a state of particular memory locations, for example, to store a binary digital electronic signal representative of content constitutes a transformation of a physical thing, for example, memory device 510, to a different state or thing.

Thus, as illustrated in various example implementations or techniques presented herein, in accordance with certain aspects, a method may be provided for use as part of a special purpose computing device or other like machine that accesses digital signals from memory or processes digital signals to establish transformed digital signals which may be stored in memory as part of one or more content files or a database specifying or otherwise associated with an index.

Some portions of the detailed description herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels.

Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other content storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics.

Though, it should be noted that this is merely an illustrative example and claimed subject matter is not limited to this example.

While certain example techniques have been described or shown herein using various methods or systems, it should be understood by those skilled in the art that various other modifications may be made, or equivalents may be substituted, without departing from claimed subject matter. Additionally, many modifications may be made to adapt a particular situation to the teachings of claimed subject matter without departing from the central concept(s) described herein. Therefore, it is intended that claimed subject matter not be limited to particular examples disclosed, but that claimed subject matter may also include all implementations falling within the scope of the appended claims, or equivalents thereof.

What is claimed is:

1. A method comprising:
generating an electronic representation of a network of associated persons; and
initiating a search query based, at least in part, on said generated network.

2. The method of claim 1, wherein said persons comprises at least one of the following: users; entities; individuals; or any combination thereof.

3. The method of claim 1, wherein said initiating comprises accessing said generated network in response to said search query.

4. The method of claim 1, wherein said persons are associated via one or more associations based, at least in part, on one or more electronic documents.

5. The method of claim 4, wherein said electronic documents comprises at least one of the following: web pages; Portable Document Format (PDF) documents; Word documents; images; audio; video; or any combination thereof.

6. The method of claim 4, wherein said one or more associations comprises at least one of the following: an educational institution; a place of employment; a physical location; or any combination thereof.

7. The method of claim 4, wherein said one or more associations are obtained, at least in part, via one or more electronic profiles of said persons.

8. The method of claim 1, and further comprising communicating a listing of returned search results for display.

9. The method of claim 8, wherein said listing of returned search results associate at least one of said persons with one or more electronic documents.

10. An apparatus comprising:
a computing platform, said platform including a capability to:
relate a plurality of persons and a plurality of electronic documents via one or more search queries in accordance with one or more mutual characteristics.

11. The apparatus of claim 10, wherein said one or more mutual characteristics comprises one or more network relationships associating said persons via said electronic documents.

12. The apparatus of claim 11, wherein said one or more network relationships are capable of being mapped.

13. The apparatus of claim 11, wherein said one or more network relationships are based, at least in part, on at least one of the following: an employment; an education; a friendship; a common interest; a kinship; a geographic location; a religious belief; or any combination thereof.

14. The apparatus of claim 10, wherein said one or more mutual characteristics are accessible via an electronic network.

15. The apparatus of claim 14, wherein said electronic network comprises at least one of the following: a private network; a public network; or any combination thereof.

16. The apparatus of claim 10, wherein said computing platform further to electronically transmit an identity of at least one of said related plurality of persons and at least one of said plurality of electronic documents in response to said one or more search queries.

17. An article comprising:
a non-transitory storage medium having instructions stored thereon executable by a special purpose computing platform to:
associate a plurality of persons based, at least in part, on a network-type structure.

18. The article of claim 17, wherein said network-type structure comprises a social structure to associate at least one of the following: users; entities; individuals; or any combination thereof.

19. The article of claim 18, wherein said social structure comprises at least one of the following: a user-related node; a web document-related node; or any combination thereof.

20. The article of claim 17, wherein said network-type structure to associate based, at least in part, on at least one of the following: an educational institution; a place of employment; or any combination thereof.
